(19) United States
(12) Patent Application Publication
(10) Pub. No.: US 2018/0369837 A1
(43) Pub. Date: Dec. 27, 2018

(54) COMPRESSED AIR DISTRIBUTOR FOR SPRAY GUN

(71) Applicant: Zhejiang Rongpeng Air Tools Co., Ltd., Taizhou (CN)

(72) Inventors: Xiaorong Li, Taizhou (CN); Fazheng Yang, Taizhou (CN); Fei Tang, Taizhou (CN); Xinbiao Ying, Taizhou (CN)

(73) Assignee: Zhejiang Rongpeng Air Tools Co., Ltd., Taizhou (CN)

(21) Appl. No.: 15/633,715

(22) Filed: Jun. 26, 2017

(51) Int. Cl. B05B 1/30

(52) U.S. Cl. CPC B05B 1/3013

(57) ABSTRACT

A compressed air distributor which is mounted on a spray gun, comprising: a compressed air inlet pipe disposed within a spray gun body, an annular gas supply pipe, an adjustment screw plug, a screw, an adjustment nut, an adjustment knob, a groove, and an adjustment through hole; wherein the center line of the adjustment through hole is eccentrically disposed on the axis line of the adjustment screw plug; wherein the bottom surface of the adjustment screw plug is coupled to an enclosed base having a connecting passage communicating with the annular gas supply pipe; when the adjustment screw plug is rotated, the adjustment through hole can be communicated with the connecting passage or sealed by the enclosed base. The compressed air distributor has a simple structure, low manufacturing cost, and is able to flexibly adjust the size of the spraying flow.

### BACKGROUND OF THE INVENTION

### (1) Field of the Invention

The present invention relates to a compressed air distributor for spray gun.

### (2) Description of the Related Art

A compressed air distributor for spray gun is connected to an inlet line of compressed air and distributing the compressed air of the inlet line to a bell mouth to a supply line and a circular injection air supply line. The existing compressed air distributor cannot meet the requirements of spraying work.

### SUMMARY OF THE INVENTION

The technical problem to be solved by the present invention is to provide a compressed air distributor for spray gun which can adjust the size of the spraying flow to meet the different spraying requirements and obtain a better spraying effect.

In order to solve the above technical problems, the technical solution of the compressed air distributor for spray gun of the present invention is:

A compressed air distributor which is mounted on a spray gun, comprising: a compressed air inlet pipe disposed within a spray gun body, an annular gas supply pipe, an adjustment screw plug disposed between the annular gas supply pipes, a screw fixedly connected to the adjustment screw plug, and an adjustment nut sleeved on the screw and matching with the adjustment screw plug; wherein the screw extends to an outside of the spray gun body 1 and has an outer end connected to an adjustment knob; wherein the adjustment screw plug includes a groove disposed in one side thereof and an adjustment through hole formed between a bottom surface of the groove and a bottom surface of the adjustment screw plug, and the center line of the adjustment through hole is eccentrically disposed on the axis line of the adjustment screw plug; wherein the bottom surface of the adjustment screw plug is coupled to an enclosed base having a connecting passage communicating with the annular gas supply pipe; when the adjustment screw plug is rotated, the adjustment through hole can be communicated with the connecting passage or sealed by the enclosed base.

More preferably, wherein the enclosed base is divided into a sealing area and an intake area by the connecting passage, said sealing area being greater than or equal to the diameter of the adjustment through hole; the connecting passage can cover the adjustment through hole.

More preferably, wherein the adjustment nut and the adjustment knob include a second O-ring disposed therebetween; and an adjustment copper washer and an adjustment gasket disposed at a position where the adjustment nut and the adjustment knob are fixed with each other; the adjustment copper washer and the adjustment gasket are stacked upon each other.

The technical effect achieved by the present invention is:

Compared with the prior art, the compressed air distributor of the present invention affects the increase or decrease of the spraying flow of the spray gun by rotating the adjustment screw plug and exposing the area in the connecting passage according to the adjustment through hole, as the adjustment through hole is located in the bottom surface of the groove and the adjustment screw ping, the structure is relatively simple, thereby reducing the production cost and improving yield.

### BRIEF DESCRIPTION OF DRAWINGS

FIG. 1 is a schematic view of a compressed air distributor for gun spray of the present invention.

### DETAILED DESCRIPTION OF THE INVENTION

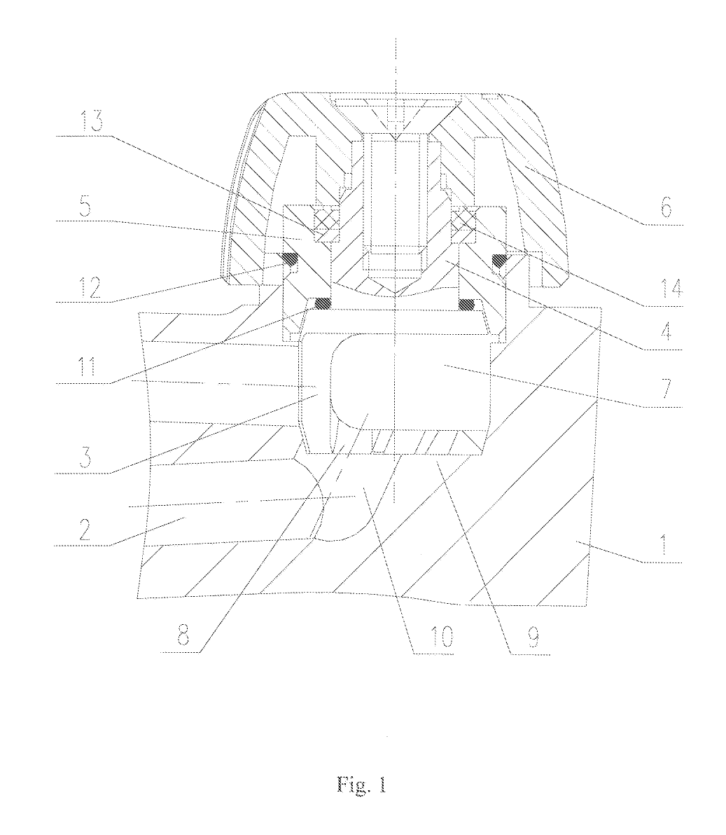

Referring to FIG. 1, the present invention provides a compressed air distributor which is mounted on a spray gun, comprising a compressed air inlet pipe 2 disposed within a spray gun body 1, an annular gas supply pipe 2, an adjustment screw plug 3 disposed between the annular gas supply pipes 2, a screw 4 fixedly connected to the adjustment screw plug 3, and an adjustment nut 5 sleeved on the screw 4 and matching with the adjustment screw plug 3. The screw 4 extends to an outside of the spray gun body 1 and has an outer end connected to an adjustment knob 6 which is a knurled knob; the adjustment screw plug 3 includes a groove 7 disposed in one side thereof and an adjustment through hole 8 formed between a bottom surface of the groove 7 and a bottom surface of the adjustment screw plug 3, and the center line of the adjustment through hole 8 is eccentrically disposed on the axis line of the adjustment screw plug 3. The bottom surface of the adjustment screw plug 3 is coupled to an enclosed base 9 having a connecting passage 10 communicating with the annular gas supply pipe 2; when the adjustment screw plug 3 is rotated, the adjustment through hole 8 can be communicated with the connecting passage 10 or sealed by the enclosed base 9.

The enclosed base 9 is divided into a sealing area and an intake area by the connecting passage 10, said sealing area being greater than or equal to the diameter of the adjustment through hole 8; the connecting passage 10 can cover the adjustment through hole 8.

The adjustment screw plug 3 and the adjustment nut 5 include a first O-ring disposed therebetween.

The adjustment nut 5 and the adjustment knob 6 include a second O-ring 12 disposed therebetween; and an adjustment copper washer 13 and an adjustment gasket 14 disposed at a position where the adjustment nut 5 and the adjustment knob 6 are fixed with each other; the adjustment copper washer 13 and the adjustment gasket 14 are stacked upon each other.

The following describes the working principle of the present invention:

The compressed air distributor for spray gun, because the adjustment through hole 8 is eccentrically disposed on the rotation shaft of the adjustment screw plug 3, when the adjustment knob 6 is rotated clockwise, the adjustment through hole 8 gradually enters the intake area of the enclosed base 9 and the communication area with the connecting passage 10 is gradually increased, finally, the adjustment through hole 8 is integrally placed within the connecting passage 10, which is the maximum air pressure supply; when the adjustment knob 6 is rotated counterclockwise, the adjustment through hole 8 is gradually covered by the sealing area of the enclosed base 9, so that the compressed air entering the connecting passage 10 through the adjustment through hole 8 is gradually reduced to a vacuum state.

The above only describes some exemplary embodiments of the present invention. Those having ordinary skills in the art may also make many modifications and improvements without departing from the conception of the invention, which shall all fall within the protection scope of the invention.

1. A compressed air distributor which is mounted on a spray gun, comprising:
an annular gas supply pipe, an adjustment screw plug connected to the annular gas supply pipes, a screw fixedly connected to the adjustment screw plug, and an adjustment nut sleeved on the screw and matching with the adjustment screw plug;
wherein the screw extends to an outside of the spray gun body and has an outer end connected to an adjustment knob;
wherein the adjustment screw plug includes a groove disposed in one side thereof and an adjustment through hole formed between a bottom surface of the groove and a bottom surface of the adjustment screw plug, and the center line of the adjustment through hole is eccentrically disposed on the axis line of the adjustment screw plug;
wherein the bottom surface of the adjustment screw plug is coupled to an enclosed base having a connecting passage communicating with the annular gas supply pipe; when the adjustment screw plug is rotated, the adjustment through hole is connected to the connecting passage or sealed by the enclosed base;
wherein the adjustment screw plug and the adjustment nut include a first O-ring disposed therebetween; the adjustment nut and the adjustment knob include a second O-ring disposed therebetween; and an adjustment copper washer and an adjustment gasket disposed at a position where the adjustment nut and the adjustment knob are fixed with each other; the adjustment copper washer and the adjustment gasket are stacked upon each other.

2. The compressed air distributor according to claim 1, wherein the enclosed base is divided into a sealing area and an intake area by the connecting passage, said sealing area being greater than or equal to the diameter of the adjustment through hole; the connecting passage can cover the adjustment through hole.

3. (canceled)
